(19) United States
(12) Patent Application Publication
(10) Pub. No.: US 2018/0053211 A1
(43) Pub. Date: Feb. 22, 2018

(54) Systems and Methods for Identifying Potential Advertising Opportunities for Events Based on Aggregate Consumer Profiles

(71) Applicant: MASTERCARD INTERNATIONAL INCORPORATED, Purchase, NY (US)

(72) Inventors: Richard William Wallen, St. Clair, MO (US); Srinivas Kosaraju, Wildwood, MO (US); Christopher John Merz, Wildwood, MO (US); David C. Youngberg, St. Charles, MO (US); William Curtis Jones, O'Fallon, IL (US)

(21) Appl. No.: 15/239,369

(22) Filed: Aug. 17, 2016

(51) Int. Cl. G06Q 30/02; G06Q 20/10; G06Q 20/18

(52) U.S. Cl. CPC G06Q 30/0255; G06Q 30/0252; G06Q 20/18; G06Q 20/10; G06Q 30/0259

(57) ABSTRACT

Systems and methods are provided for identifying advertising opportunities for subsequent events, based on event data and transaction data for similar prior events. One exemplary method includes accessing event data associated with a prior event where the event data includes tags associated with the prior event, and accessing transaction data for consumers based on transactions by the consumers involving merchants associated with the prior event. The method also includes compiling an aggregate consumer profile for the consumers based on the accessed transaction data, where the profile includes categories of transactions included in the transaction data. The method further includes causing an insight interface to be delivered to a user associated with a subsequent event based on the aggregate consumer profile and the event data, whereby the user is able to identify potential advertising opportunities for the subsequent event via the insight interface for the prior event.

### FIELD

The present disclosure generally relates to systems and methods for identifying potential advertising opportunities for events (e.g., entertainment events, educational events, etc.) based, at least in part, on aggregate consumer profiles associated with prior events.

### BACKGROUND

This section provides background information related to the present disclosure which is not necessarily prior art.

Consumers use payment accounts to purchase various different types of products (e.g., good and services, etc.). Transaction data is known to be generated for purchase transactions to the payment accounts. The transaction data is representative of details of the purchase transactions (e.g., merchant IDs for merchants involved in the transactions, merchant categories, dates/times of the transactions, products purchased in the transactions, etc.). The transaction data is then often used to direct advertising to various ones of the consumers, as compared to others, based on the consumers' prior purchases of products and/or the consumers' prior purchases at particular merchants. Separately, organizers of events are known to coordinate events and offer tickets for sale for attendees (e.g., the consumers, etc.) to gain access to the events. At the events, merchants are often set up to offer products for sale to the attendees (e.g., refreshments, souvenirs, etc.). The events are further known to be listed on various web-based forums, through which consumers are permitted to search for desired events, such as, for example, concerts, etc., and provide reviews and commentary about the events, performers/performances at the events, venues, etc.

### DRAWINGS

The drawings described herein are for illustrative purposes only of selected embodiments and not all possible implementations.

FIG. 1 is a block diagram of an exemplary system of the present disclosure suitable for use in identifying potential advertising opportunities for events based, at least in part, on aggregate consumer profiles;

FIG. 2 is a block diagram of a computing device that may be used in the exemplary system of FIG. 1;

FIG. 3 is an exemplary method, which may be implemented in the system of FIG. 1, for identifying potential advertising opportunities for events based, at least in part, on aggregate consumer profiles; and

FIGS. 4-6 are exemplary insight interfaces, which may be displayed in connection with the system of FIG. 1 and/or the method of FIG. 3, to permit a user to identify potential advertising opportunities for certain events.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Products (e.g., goods and/or services, etc.) are often purchased by consumers through payment accounts, causing transaction data to be generated. Advertising for such products generally varies in effectiveness based on the ability of an advertiser to target those individuals interested in the products. Separately, event organizers coordinate events and offer/advertise tickets for sale, for example, to the consumers, to access the events and/or merchandise for sale relating to the events. In addition, the events may be the subject of web-based forums (e.g., web-sites, web-based applications, etc.), through which the consumers are able to provide content related to the events (e.g., reviews, commentary, etc.) and further request alerts, notifications, etc. regarding the events. Uniquely, the systems and methods herein access event data for the events, associated with the web-based forums, and also transaction data associated with the consumers at the events (i.e., the consumers attending the events), to provide insights into the consumers at the events. In particular, the event data, for one (or multiple) selected event(s), is compiled into a data structure representative of the content provided by the consumers (or others) about the event(s). Separately, the transaction data associated with transactions to payment accounts for the various consumers at the event(s), including for actual transactions at the event(s), is compiled in an aggregate consumer profile for the consumers. The event data structure and the aggregate consumer profile are then incorporated into insight interfaces, for display to users associated with advertising for subsequent events. In this manner, the users are permitted to identify potential advertising opportunities for the subsequent events, based on correlations between the event data and the aggregate consumer profiles, to increase the probability of reaching consumers interested and/or desiring to attend the subsequent events and/or purchase associated products.

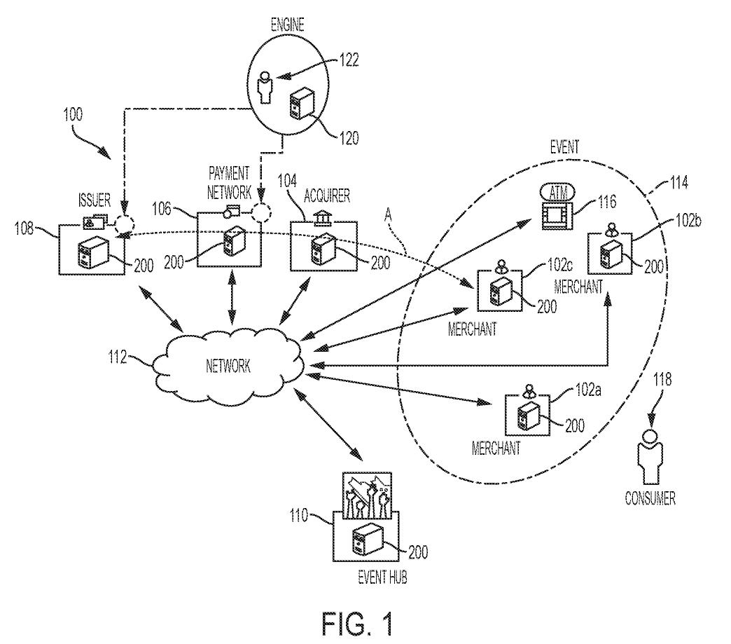

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, manners of gathering event data and/or processing transactions to consumer payment accounts, etc.

The system 100 generally includes multiple merchants 102a-c, an acquirer 104, a payment network 106, an issuer 108, and an event hub 110, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which may provide interconnection between (or other access to) the merchants 102a-c, the payment network 106, and the event hub 110, etc.

Each of the merchants 102a-c is generally associated with products (e.g., goods and/or services, etc.) for purchase by one or more consumers (e.g., consumer 118, etc.). Further, in this exemplary embodiment, each of the merchants 102a-c is associated with an event 114, such as, for example, an entertainment event, educational event, social event, etc. Entertainment events may include, without limitation, concerts, plays, festivals, theatre performances, operas, games (e.g., baseball games, football games, etc.), parties, matches, shows, movies, and/or other events, which consumers attend for entertainment, etc. Social events or other events may include any type of event, in which attendance is generally controlled (e.g., by purchase of tickets, etc.), and where organizers of the events may seek to advertise to increase and/or facilitate attendance at the events. In the system 100, the merchants 102a-c, in turn, are present at the event 114 and offer products to consumers in attendance at the event 114 (such as the consumer 118), etc. The products may include, for example, souvenirs, concessions, refreshments, food, tickets, brochures, etc. In addition, as shown in FIG. 1, an automated teller machine (ATM) 116 is disposed at the event 114, to permit consumers (including the consumer 118) to withdraw cash, which may then also be used to fund purchases at the merchants 102a-c.

The consumer 118, in the system 100, is associated with a payment account (or with multiple payment accounts) (not shown) through which the consumer 118 is able to cause payment account transactions for products involving, among others, one or more of the merchants 102a-c at the event 114, and/or cause withdrawal transactions at the ATM 116 (when the consumer's payment account being used includes sufficient funds to do so).

In connection with a purchase transaction between the consumer 118 and the merchant 102c, for example, for the purchase of a product, the consumer 118 presents a payment device, associated with the consumer's payment account, to the merchant 102c. In turn, the merchant 102c reads account information from the payment device and submits an authorization request to the acquirer 104 for the transaction, consistent with path A in FIG. 1. The authorization request may include, for example, a payment account number (e.g., a primary account number (PAN), etc.), an amount of the transaction, a merchant ID for the merchant 102c, and/or additional information as desired and/or as necessary to process the transaction, etc. The acquirer 104 communicates the authorization request to the issuer 108, consistent with path A, through the payment network 106, such as, for example, through MasterCard®, VISA®, Discover®, American Express®, etc., to determine (by the issuer 108) whether the payment account is in good standing and whether there is sufficient credit and/or funds to complete the transaction. If the issuer 108 accepts the transaction, an authorization reply indicating approval is provided back to the acquirer 104 and the merchant 102c, thereby permitting the merchant 102c to complete the transaction. The transaction is later cleared and/or settled by and between the merchant 102c and the acquirer 104 (via an agreement between the merchant 102c and the acquirer 104), and by and between the acquirer 104 and the issuer 108 (via an agreement between the acquirer 104 and the issuer 108) (through further communication therebetween). If the issuer 108 declines the transaction, however, an authorization reply indicating decline is provided back to the merchant 102c, thereby permitting the merchant 102c to terminate the transaction, or request an alternate form of payment.

With respect to the ATM 116 in the system 100, a withdrawal transaction by the consumer 118, for example, is substantially consistent with the above, with the authorization request originating from the ATM 116 in response to a withdrawal instruction from the consumer 118. In one or more instances, the account to which the transaction is directed is a bank account or debit account, which may or may not be suitable to fund purchase transactions at the merchants 102a-c.

Transaction data is generated, collected, and stored as part of the above interactions among the merchant 102a-c (or ATM 116), the acquirer 104, the payment network 106, the issuer 108, and the consumer 118. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure, or transaction data may be transmitted between parts of system 100, as used or needed. Transaction data as used herein may include, for example, payment account numbers, amounts of the transactions, merchant IDs, merchant category codes (MCCs), dates/times of the transactions, products purchased and related descriptions or identifiers, etc.

In various exemplary embodiments, the consumers (e.g., consumer 118, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions, subsequently for one or more of the different purposes described herein.

With continued reference to FIG. 1, the event hub 110 of the system 100 is associated with the event 114 (and potentially with multiple other events), and provides a forum for the organizer of the event 114 to provide details of the event 114 and, in some examples, to offer tickets to the event 114 for sale to consumers (including to the consumer 118). In general, the event hub 110 is a data source related to the event 114 (and potentially other events), which, as described above, may include an entertainment event, an educational event, a social event, or another type of event.

The event hub 110 is also consumer driven, in part, as it permits consumers (e.g., the consumer 118, etc.) to create accounts (broadly, profiles), through which the consumers 118 are able to track the event 114 (and potentially other events), search for the event 114 (e.g., via a search request, etc.), provide content related to the event 114 (e.g., reviews, etc.), and/or provide content related to various parts of the event 114. As such, via the event hub 110, for example, the consumer 118 may, for example, be permitted to search for the event 114 (from listings of various events known to the event hub 110) by a performer at the event 114, a subject of the event 114, a venue for the event 114, a date for the event, or a keyword related to the event 114 (e.g., country, rock, bull riding, etc.). Often, the content offered/provided by the consumers (e.g., commentary, reviews, descriptions, etc.) to the event hub 110 is also posted, such that other consumers are able to view the content. The content is generally descriptive of the corresponding event (e.g., event 114, etc.), or parts thereof. One example event hub 110 includes the Eventful® website, accessible at www.eventful.com.

The event hub 110 is configured with application programming interfaces, or APIs, made available through network 112. The APIs enable third parties (e.g., the payment network 106, an event engine 120, etc.), given the proper permissions, to access and/or retrieve event data compiled at the event hub 110 for the event 114, for example, and for other events associated with the event hub 110 (e.g., in response to a search by a user 122 via the event engine 120, etc.). The access provided by the APIs is often general to multiple consumers, and specific to the event 114, the venue for the event 114, a performer at the event 114, or series of events (including the event 114). However, in some implementations, the access may be specific to one or more consumers, by criteria (e.g., postal code, area code, gender, age, etc.), etc. The event data accessed and/or retrieved may include content from the consumer 118 (or from other consumers) and/or from the organizer of the event 114 (or from other organizers), which is analyzed, compiled, and/or processed by the event hub 110. In addition (or alternatively), the event data may include raw content in the form provided by the consumers (e.g., consumer 118, etc.) and/or the organizers, or combinations thereof. Generally, the event data includes tags, and may further include temporal indicators of when the tags were provided (e.g., dates/times, etc.), as well as locations (e.g., addresses, regions (e.g., postal codes, area codes, etc.), etc.) of origins of the tags, etc.

In the illustrated system 100, the event hub 110 is a separate, stand-alone part of the system 100. In other embodiments, however, the event hub 110 may be incorporated, at least in part, with one or more other parts of the system 100. For example, in one embodiment, in which the event hub 110 permits sales of tickets, the event hub 110 may be consistent with a merchant (such as the merchant 102c), in that purchase transactions for the tickets generally follow along path A (shown in FIG. 1) and are permitted between the event hub 110 and the issuer 108, through the payment network 106. Transaction data associated with such purchase transactions for the tickets, when funded by payment accounts, is also stored consistent with the above description.

It should be appreciated that the event hub 110 may be modified in a variety of manners, such that the event hub 110 may incorporate a variety of additional and/or alternative operations related to one or more events. Further, while three merchants 102a-c, one acquirer 104, one payment network 106, one issuer 108, one event hub 110, and one consumer 118, are illustrated in FIG. 1, it should be appreciated that any number of these parts (and their associated parts, including third parties) may be included in the system 100, or may be included as one or more parts of systems in other embodiments, consistent with the present disclosure.

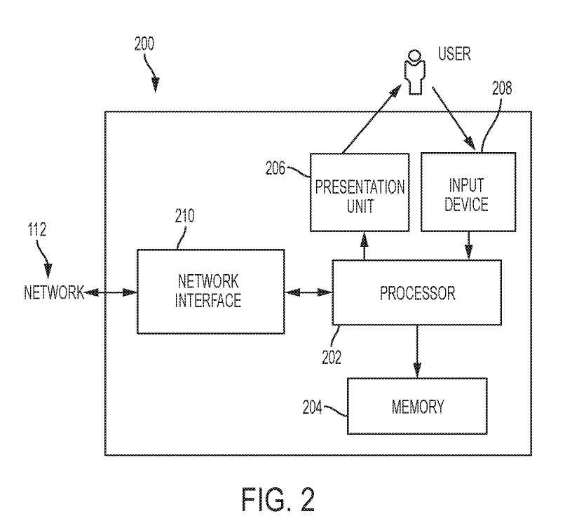

FIG. 2 illustrates an exemplary computing device 200 that can be used in the system 100. The computing device 200 may include, for example, one or more servers, workstations, personal computers, laptops, tablets, smartphones, point-of-sale (POS) terminals, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchants 102a-c, the acquirer 104, the payment network 106, the issuer 108, and the event hub 110 is illustrated as including, or being implemented in, a computing device 200, coupled to the network 112. Further, the computing devices 200 associated with these parts, for example, may include a single computing device, or multiple computing devices located in close proximity or distributed over a geographic region, again so long as the computing devices are configured, often by computer-executable instructions, to function as described herein. In addition, the ATM 116 and the event engine 120 of the system 100 may each be considered a computing device, consistent with computing device 200.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, event data (e.g., tags, etc.), transaction data, interfaces, consumer content (e.g., commentary, reviews, descriptions, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., interfaces, etc.), visually, for example, to a user of the computing device 200 such as the consumer 118 in the system 100, etc. It should be further appreciated that various interfaces (e.g., as defined by internet-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of events for which event data is to be gathered, etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202.

Referring again to FIG. 1, the event engine 120 of the system 100 is specifically configured, via executable instructions, to perform one or more of the operations herein. As shown, and as described above, the event engine 120 is illustrated as separate from the payment network 106 and the issuer 108, as a standalone part or entity. As such, the event engine 120 may operate apart from the payment network 106 and/or issuer 108, as part of another entity, such as, for example, an advertising entity. In one example, the engine 120 is incorporated in an advertising entity associated with the event hub 110 and/or an organizer associated with one or more events (e.g., the event 114, etc.). In other examples, and as indicated by the dotted lines in FIG. 1, the event engine 120 may additionally, or alternatively, be incorporated, in whole or in part, into the payment network 106 and/or the issuer 108. In addition, in still other embodiments, the engine 120 may be incorporated with other parts of the system 100 (e.g., the acquirer 104, one or more of the merchants 102a-c, etc.). The event engine 120 should further be understood to be embodied in at least one computing device, specifically configured to perform as described herein, which, again, may be consistent with the computing device 200, and/or embodied in at least one non-transitory computer readable media.

The event engine 120 is associated with user 122. The user 122 may include, for example, an employee, agent, or other person to act as provided herein. The user 122 is often also associated with a subsequent event or multiple subsequent events (e.g., employed by, directed by (directly or indirectly), etc.), for which the user 122 is attempting to identify advertising opportunities based on data for prior events (e.g., event 114, etc.). For example, the user 122 may be associated with one of the merchants 102a-c, with an advertiser or other entity associated therewith, etc., and may work to provide advertising for subsequent events at which the merchants may be present, etc. Specifically, the user 122 is provided to select the prior event and/or events, from which the event engine 120 operates.

In this exemplary embodiment, the event engine 120 is configured to access event data for prior events (e.g., metadata for the events including times, locations, etc.) that are selected by the user 122 (e.g., for event 114, etc.). The event data is accessed, by the engine 120, either from the event hub 110, for example, via one or more APIs associated therewith, or from memory 204 (i.e., previously retrieved event data), etc. The engine 120 is configured to also compile an event data structure representative of tags included in the accessed event data.

In particular, the event engine 120 may be configured to access event data (for an exemplary event), as defined, for example, at least in part by the following exemplary instructions:

```
import eventful
import codecs
import sys
UTF8Writer = codecs.getwriter(′utf8′)
sys.stdout = UTF8Writer(sys.stdout)
sys.stdout.write(′.′) # CJM
api = eventful.API(′[user key]′, cache=′.cache′)
event_list=[′E0-001-076623912-9′,′E0-001-070661227-6′,′E0-001-
082680063-6′,′E0-001-077874483-7′,′E0-001-081043891-5′,′E0-
001-080884408-9′,′E0-001-078447182-6′,′E0-001-073534301-1′,′E0-001-
070899711-7@2015030115′,′E0-001-079780878-3′,′E0-001-080874927-
0′,′E0-001-080715377-7′,′E0-001-074419367-6@2015021519′,′E0-001-
077373919-5′,′E0-001-076623990-7′]
for event_item in event_list:
  event = api.call(′/events/get′, id=event_item)
  tag_id = event[′id′]
  tags = api.call(′/events/tags/list′, id=tag_id)
  #print ′%s′ % (event[′id′]),
  fname = ″/Users/johnsmith/rwd/my_app/tagged_events/
″+event[′id′]+″.txt″
  sys.stdout = open(fname, ′w′)
  for tag in tags[′tags′][′tag′]:
    print ′\t%s′ % (tag[′title′]),
  print(′ ′)
```

Separately, the event engine 120 is configured to access transaction data regarding transactions for consumers present at the prior events (and potentially other consumers) and to filter the transaction data to substantially limit the transaction data to transactions associated with the prior events (e.g., event 114, etc.). The accessing and/or filtering may be based on, for example, merchants known to be associated with the events or venues of the events (e.g., based on location, etc.) (e.g., merchants 102a-c at event 114, etc.), a time associated with the events, a date associated with the events, predefined intervals (e.g., 30 days, etc.), etc. The engine 120 is configured to then generate an aggregate profile (e.g., a data structure, etc.) for the consumers present at the prior events, based on the filtered transaction data, which may include, for example, a listing of keywords and/or categories of purchases.

In particular, the event engine 120 may be configured to access transaction data, as defined, for example, at least in part by the following exemplary instructions (e.g., contained in files with the exemplary names “event_txns_all_enc.sql,” “event_txns_enc.sql,” “event_zip_code_enc.sql,” and “extract_by_event.shl,” respectively below; etc.):

```
insert into event_txns_all_enc
select
    [[list of variables to be retrieved]]
from [[transaction data storage]] a
  inner join temp_event_cards_all_enc c
    on (a.process_date = c.process_date and a.sequence_nbr = c.dw_sequence_nbr)
  inner join hadoop..temp_event_txns_flat_enc b
    on ( c. card_nbr = b. card_nbr)
order by [[list order variables]];
create table event_txns_enc as
select
  [[list of variables to be retrieved]]
from [[transaction data storage]] a inner join hadoop..EVENT_LOC_IDS b
  on ( a. merch_location_id = b.old_loc_id) inner join hadoop..events c
  on (a. TXN_DATE = date(c.EVENT_START_TIME) )
    inner join core..clearing_detail_current_yr_enc d
  on (a. process_date = d. process_date and a. sequence_nbr = d. sequence_nbr)
order by [[list order variables]];
distribute on ([[list order variables]];);
create table event_zip_code_enc as
select a. card_nbr,
  b.zip_code
from EVENT_TXNS_ALL_INDUSTRY_ENC a join
POSTAL_CODE_MODELS..RES_ZIP_MODELS b
on ( lower(rawtohex(hash(rpad(a. CARD_NBR ,′ ′), 2))) = b. card_nbr )
distribute on ([[list order variables]]);
#!/bin/ksh
nzsql -t -A -d hadoop -c ″select distinct event_id from event_txns_all_industry enc″ |
while read_event_id
do
    echo ″Starting - ${_event_id} ″
    nzsql -t -A -d hadoop -c ″select b.industry_name from event_txns_all_industry_enc a
join [[transaction data storage]];b \
      on (a.industry = b.INDUSTRY) where a.event_id = 3 ${_event_id};″
> ${_event_id}.dat
    echo ″End - ${_event_id}″
done
exit 0
```

It should be appreciated that the exemplary instructions included herein are exemplary only, and not intended to be limiting of the manner in which the event engine 120 is configured. Based on the above (and also the exemplary instructions included in the Computer Code Appendix below), the same, different and/or other instructions in various forms would be understood by those skilled in the art to be within the scope of the present disclosure.

The event engine 120 is further configured to compile insight interfaces for the particular prior events (e.g., for event 114, etc.). In so doing, the event engine 120 generally highlights various transactions that stand out among the consumers present at the prior events. The insight interfaces generally include, for example, a representation of the tags (e.g., graphically, textually, etc.) for the events indicating the frequency and/or prevalence of the tags (broadly, a measure), in combination with a representation of the categories of the aggregate profiles indicating the frequency and/or prevalence of the categories (broadly, a measure). In addition, further data about the events, purchases underlying the aggregate profiles, and/or consumers underlying the aggregate profiles may be included in the insight interfaces, such as, for example, locations, counts, demographics, etc. The engine 120 is configured to then cause the interfaces to be displayed to the user 122, associated with the event engine 120. The user 122 is permitted, by the event engine 120, to manipulated, filter, and/or alter the data (or the representation of the data) included in the interfaces, in a variety of manners, to enable the user 122 to gain insight into the events, and/or to direct advertising to consumers (such as consumer 118) for subsequent events of the same types and/or categories as the prior events, and/or for associated products offered for sale from merchants at the subsequent events, etc.

In particular, the event engine 120 may be configured to compile insight interfaces (for example events), as defined, for example, at least in part by the exemplary instructions included in the Computer Code Appendix below (e.g., and contained in files with the exemplary names “server.R” and “ui.R” that include instructions found at and/or derived from http://shiny.rstudio.com/gallery/superzip-example.html (which is incorporated herein by reference in its entirety); etc.).

It should be appreciated that the above code segments (and instructions) are exemplary only, and illustrative of operations described herein, but may be altered and/or expanded upon to perform other operations described herein, or as necessary or desired, and/or to perform operations in one or more different manners.

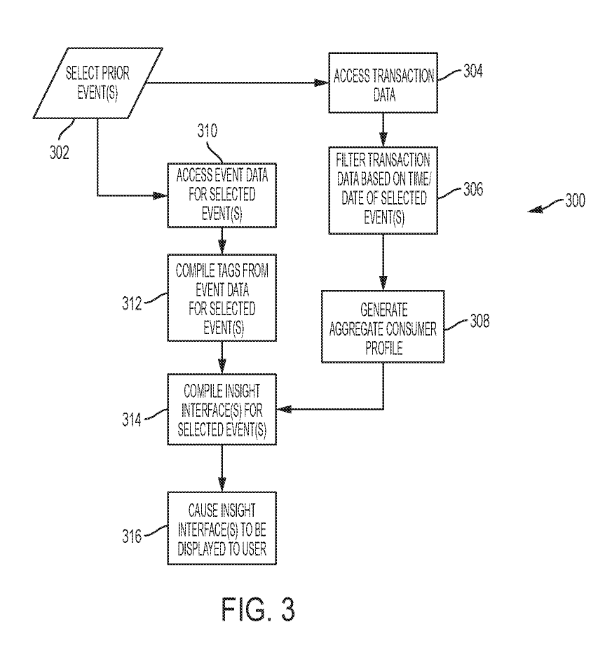

FIG. 3 illustrates an exemplary method 300 for use in directing advertising to consumers based on event data for prior events and transaction data associated therewith. The exemplary method 300 is described as implemented in the event engine 120 of system 100, and further with reference to the computing device 200. However, it should be understood that the method 300 is not limited to this configuration. As such, the methods herein should not be understood to be limited to the exemplary system 100 or the exemplary computing device 200, and likewise, the systems and the computing devices herein should not be understood to be limited to the exemplary method 300.

As shown in FIG. 3, the user 122, associated with the event engine 120, initially selects, at 302, via the event engine 120, a prior event or events, for example, event 114 in the following description, from which one or more insight interfaces is to be compiled (for a subsequent or future event, etc.). Often, for example, the user 122 selects an event like in kind and/or type to the subsequent event, for which advertising is to be planned. It should be appreciated that in one or more embodiments, the user 122 may provide a keyword, a category or other criteria associated with the subsequent event in connection with a search, with which the event engine 120 would then identify the prior event 114, for example, suitable for selection (e.g., through the event hub 110, etc.). The event engine 120 may offer the identified event 114 to the user 122 for the user's selection (from multiple different events), or may proceed with the identified event 114 as the selected event.

As an example, when the future event involves a performance of Band ABC, the user 122 (e.g., in association with an advertising entity for the future event, etc.), via the event engine 122, may select event 114 when associated with a prior performance of Band ABC or a prior performance of a common genre band, Band XYZ, in order to gain insight into how to advertise for the subsequent performance of the Band ABC at the future event. This may also be effective when tickets are still available for the future event (i.e., the future performance of Band ABC is not sold out). The user 122 may then use the results to determine where to allocate (or how to reallocate) remaining advertising money, in attempt to sell the remaining tickets.

Upon selection of the event 114 for use as the advertising basis, the event engine 120 accesses, at 304, transaction data for multiple payment accounts. The transaction data accessed by the event engine 120 may include all transaction data available to the event engine 120, or it may be limited, for example, based on the selected event 114, other parameters, etc., as described more below. The engine 120 may access the transaction data in a local data structure (e.g., in memory 204, etc.), populated with transaction data retrieved from the payment network 106 (or acquirer 104 or issuer 108, etc.), or the engine 120 may retrieve the transaction data from the payment network 106 (or acquirer 104 or issuer 108, etc.). In either case, the transaction data may be accessed based on a variety of parameters associated with the transaction data, such as, for example, a predefined interval (e.g., transaction data for the last 30 days, the last 60 days, the last 120 days, etc.), a region of the selected event 114 (e.g., transaction data for regions having a postal code, a state, a country, etc. matching that of the selected event 114), the identified merchants 102a-c at the selected event 114 (e.g., transaction data involving one or more of the merchants 102a-c, etc.), etc. The transaction data, as suggested above, includes various types of data related to the underlying transactions, including, for example, category codes, MCCs, times/dates, merchant IDs, merchant types, purchase locations (e.g., zip codes, etc.), inferred consumer locations (e.g., residential zip codes, etc.), amounts spent, channels of spend (e.g., online, brick and mortar, etc.), etc. In various embodiments, the accessed transaction data is further organized by payment account.

The event engine 120 then filters the accessed transaction data, at 306, based on at least a time and date for the selected event 114. More specifically, the event engine 120 eliminates accessed transaction data for payment accounts that lack transaction activity at the time/date of the event 114. For example, for the future performance by Band ABC described above, one of the prior performances of Band ABC may have been November 12 at 9:00 PM, which may cause the event engine 120 to filter out accessed transaction data for all payment accounts, except those including transactions occurring between 7:00 PM on November 12 and 1:00 AM on November 13. It should be appreciated that the time/date filter may vary in duration, potentially depending on, for example, a type of the prior event 114, a duration of the prior event 114, and/or a propensity of the prior event 114 to extend forward or backward in time (e.g., tailgating prior to a football game, etc.).

In addition to filtering based on the time/date of the event 114 (or potentially as part of the filtering), the event engine 120 also limits the accessed transaction data to those payment accounts including at least one transaction with one of the merchants 102a-c associated with the selected event 114 or with the ATM 116. In this manner, the event engine 120 potentially captures substantially only transactions from one or more of the merchants 102a-c and the ATM 116 at the prior event 114 (in order to provide a more focused group of consumers and transaction data for implementing advertising decisions for the future event at issue). This further limiting operation, performed by the event engine 120, may be accomplished by utilizing data from an organizer of the event 114, or from the merchants 102a-c, or from the banking entity associated with the ATM 116, or other means, to obtain the necessary information to allow the further limiting operation to be performed on the accessed transaction data.

In order to identify the merchants 102a-c and the ATM 116 at the selected event 114 (and potentially other merchants, ATMs, etc. to be considered), the transaction data (or points of sale) may be assigned to groups. One such group may be associated with on-premises transactions taking place at entities or other devices (such as the ATM 116, vending machines at the venue, etc.) owned by the venue hosting the selected event 114 (e.g., as determined based on transaction data for the transactions having the same merchant name as the venue (or event 114), the same transaction location as the venue, etc.). Another such group may be associated with nearby transactions, taking place near the venue hosting the selected event 114 and having a strong share with the event 114 (e.g., as determined by a threshold relationship to the event 114 and/or venue, etc.) of common accounts within a predefined event timeframe. These groups can be generated per event, or they can be established over time (and potentially updated as needed). In the former case, a merchant whose address may not be near the venue of the event 114 may still be considered a nearby point of sale for the event 114 if it has co-transactions with other event merchants 102a-c or with the ATM 116 in the same event timeframe. In the latter case, transactions that occur frequently across multiple events taking place at the same venue may be compiled into a group for that venue, for example, all of the concession stands in a stadium (on premises) and the bar/restaurant across the street (nearby).

It should be appreciated that the transaction data may be accessed and/or filtered (and/or limited) based on the same or different criteria in other embodiments. For example, the transaction data may be accessed, by the event engine 120, based on the time/date of the selected event 114, whereby subsequent filtering based on that same criteria would be unnecessary. Additionally, or alternatively, the transaction data may be accessed, by the event engine 120, based on geographic region of the selected event 114, etc., again reducing the need for subsequent filtering.

Then in the method 300, based on the accessed and/or filtered (and/or limited) transaction data, the event engine 120 then compiles an aggregate consumer profile, at 308. The aggregate consumer profile may include, for example, a listing of categories in which transactions (based on the accessed transaction data) were made in the last 30 days (or during another interval), and a count (broadly, a measure) indicating the number of purchases in each category.

Table 1 illustrates a part of an exemplary aggregate consumer profile for the Band ABC (when associated with the event 114, for example). The table generally includes a listing of categories/industries included in the accessed transaction data (as filtered and/or limited), and a number (or count) of transactions taking place in each category (as summed from the accessed transaction data).

TABLE 1

| Category | Count |
|---|---|
| Accommodations | 201 |
| Automotive Retail | 99 |
| Department Stores | 198 |
| Financial Services | 96 |
| Florists | 96 |
| Home Improvement Centers | 98 |
| Wholesale Clubs | 106 |
| Wholesale Trade | 242 |
| . . . | |

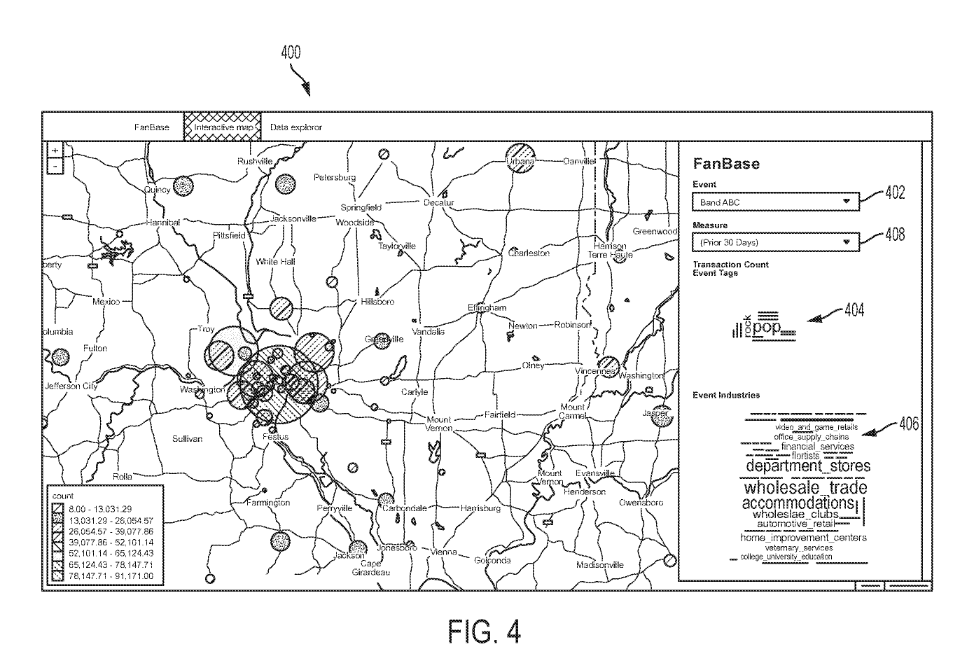

As shown in Table 1, the exemplary aggregate consumer profile includes 201 transactions made to merchants in the “Accommodations” category/industry, 99 transactions made to merchants in the “Automotive Retail” category/industry, and so on. While the illustrated aggregate consumer profile includes an indication of transaction count for the different categories within the accessed transaction data, the event engine 120, in some embodiments, may process the transaction data to represent the frequency of the transactions in each category, total value of the transactions in each category, etc. Specifically, for example, the event engine 120 may determine and/or calculate a term frequency-inverse document frequency (TF-IDF) for each of the categories, which may be understood to indicate the frequency (e.g., importance, etc.) of the categories within the transaction data. When used, TF-IDF may help show what is unique about an event's industries versus all other in the corpus of events, such that industries that are particularly unique to an event generally show up larger (as described more in connection with FIGS. 4-6). It should be appreciated that the frequency may be represented in any variety of manners, for use as described herein.

With continued reference to FIG. 3, separate from accessing the transaction data, the event engine 120 also accesses, at 310, event data associated with the selected event 114. Like above, to access the event data, the event engine 120 may retrieve the event data from the event hub 110, via at least one API, for example, or access the event data (in memory 204, for example), which was previously retrieved from the event hub 110. Once accessed, the event engine 120 compiles, at 312, the keywords, categories, etc. (broadly, tags) included in the event data for the events 114 into a data structure, along with a frequency or recurrence of the tags in the event data (broadly, a count).

Table 2 illustrates an exemplary data structure of tags, from event data retrieved from the event hub 110, for the Band ABC. The table generally includes a listing of tags included in the accessed event data, and a count of occurrences of each tag in the event data. It should be appreciated that the compiled tags in the data structure will generally be specific to the selected event 114 (i.e., the Band ABC in this example), as determined at 302 in the method 300.

TABLE 2

| Tags | Count |
|---|---|
| Arts | 1 |
| concert | 1 |
| music | 1 |
| Pop | 89 |
| Rock | 72 |
| stubhub | 1 |
| theater | 1 |
| ticketmaster | 1 |
| tickets | 1 |
| . . . | |

As shown in Table 2, in this example, the Pop tag includes 89 occurrences, the Rock tag includes 72 occurrences, and each of the remaining tags includes a single occurrence in the event data. While the data structure in Table 2 includes an indication of count of the multiple tags within the accessed event data for the Band ABC, the event engine 120, in some embodiments, may process the event data to represent the frequency of the tags, relative to the event data, in a different manner. Specifically, for example, the event engine 120 may determine and/or calculate a term frequency-inverse document frequency (TF-IDF) for each of the tags, which may be understood to indicate the frequency (e.g., importance) of the tags within the event data. When used, TF-IDF may help show what is unique about an event's tags versus all other in the corpus of events, such that tags that are particularly unique to an event generally show up larger (as described more in connection with FIGS. 4-6). It should be appreciated that the frequency may be represented in any variety of manners, for use as described herein.

Next in the method 300, based on the aggregate consumer profile (generated at 308) and the tags compiled in the data structure (at 312), the event engine 120 compiles an insight interface for the selected event 114, at 314. Generally, the insight interface includes a representation of the aggregate consumer profile and the tag data structure. Once compiled, the event engine 120 then causes the insight interface to be displayed to the user 122, at 316, for example, at presentation unit 206 of computing device 200, directly or via network 112.

FIGS. 4-6 illustrate three exemplary insight interfaces compiled by the event engine 120, for example, in accordance with the method 300, each based on a different selected event.

FIG. 4 illustrates an exemplary insight interface 400, compiled by the event engine 120 based on a prior event associated with the Band ABC. The prior event is indicated in the interface 400 at drop-down menu 402, which allows a user to alternatively select other events as desired. In response to a different event selection, the event engine 120 may return to a prior operation in method 300, as needed, for example, to compile the modified insight interface.

In the illustrated insight interface 400, the event tags from the accessed event data for the Band ABC (accessed from the event hub 110) are represented by tag symbols 404, with the size and/or color of the tag symbols 404 being indicative of the frequency (e.g., based on TF-IDF, etc.) of the corresponding tag's presence in the accessed event data. In the insight interface 400, the tag symbol “pop” is larger in size (and, in some embodiments, of different color) than the tag symbol “rock,” indicating that it was more prevalent in the accessed event data. In the interface 400, the tag symbols 404 are represented as text symbols, indicating the particular tags each represents. In other embodiments, the tags may be represented by other symbols (other than text, for example, such as images, etc.). Also in the illustrated interface 400, the categories (or industries) from the accessed transaction data for the selected event are represented by symbols 406. As shown, the insight interface 400 includes multiple different categories/industries. Again, the categories are represented by text symbols, with the size of the text symbol indicative of the frequency (e.g., based on TF-IDF, etc.) of transactions in the accessed transaction data at merchants in those categories. Alternatively, the categories could be represented by other symbols, and/or may utilize different colors to indicate different frequencies of transactions at the different categories.

The illustrated insight interface 400 also includes a map of the geographic region for the selected event associated with the Band ABC. As shown, the map includes indicators, i.e., rounded discs, representing a selected measure from pulldown menu 406. In the illustrated interface 400, transaction count is selected as the measure at the pulldown menu 408, but alternatively the measure could include average money spent, total money spent, transaction frequency, transaction averages (per time period) or other averages, other available measures, etc. The indicators are then located on the map according to a merchant zip code of where the underlying transactions were observed. Alternatively, the indicators could be located based on residence of the consumers performing the transactions (e.g., based on residential zip code, etc.). In any case, in response to a different selection at the drop-down menu 408, the event engine 120 may return to a prior operation in method 300, as needed, for example, to compile the modified insight interface.

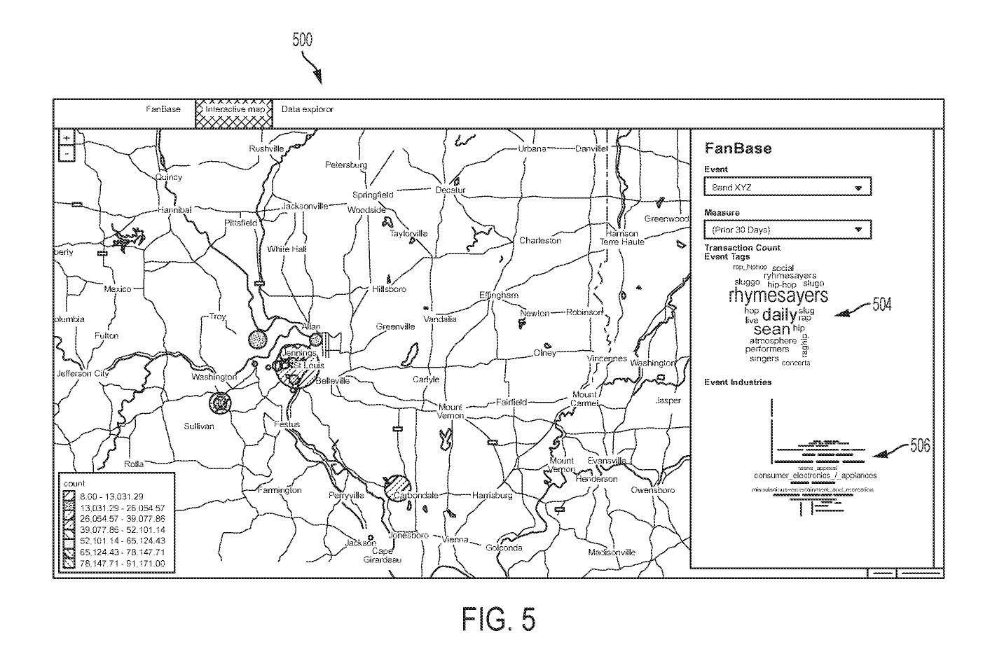

FIG. 5 illustrates another exemplary insight interface 500, compiled by the event engine 120 based on a prior event associated with the Band XYZ. Again, and as in insight interface 400, the event tags from the accessed event data for the Band XYZ are represented by tag symbols 504 (that are text), with the size of the symbols 504 being indicative of the frequency of the corresponding tag's presence in the event data. The “rhymesayers” tag is larger in size than the “singles” tag, indicating that it was more prevalent in the accessed event data. In addition, the categories (or industries) from the accessed transaction data for the event associated with the Band XYZ are represented by symbols 506. As shown, the insight interface 500 again includes multiple different categories/industries, with the size of the symbols 506 again indicative of the frequency of transactions in the accessed transaction data at merchants in those categories. For example, the “consumer electronics/appliances” category is larger in size than the “dating” category, indicating that more transactions were made at merchants in this category.

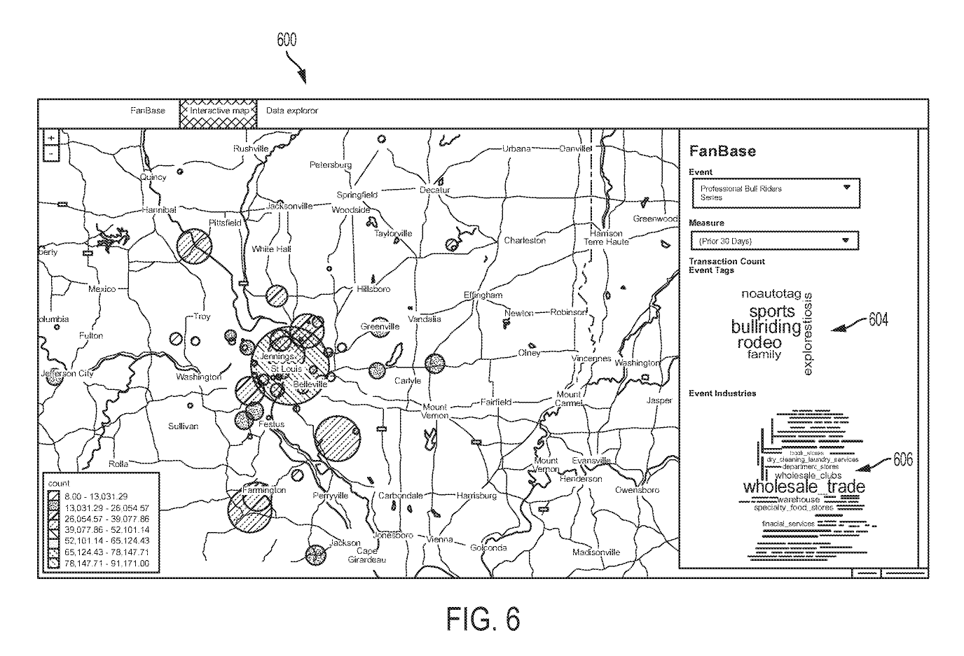

FIG. 6 illustrates another exemplary insight interface 600, compiled by the event engine 120 based on a prior bull riding event (e.g., as selected by the event engine at 302 in the method 300, etc.). Again, the event tags from the accessed event data for the bull riding event are represented by tag symbols 604 (that are text), with the size of the symbols 604 being indicative of the frequency of the corresponding tag's presence in the event data. In addition, the categories (or industries) from the accessed transaction data for the bull riding event are represented by symbols 606. The insight interface 600 again includes more than 20 different categories/industries, with the size of the symbols 506 indicative of the frequency of transactions in the accessed transaction data at merchants in those categories.

In view of the above, the user can be presented information, through the insight interfaces 400, 500, 600, from the event engine 120, to determine where and/or how to allocate advertising resources for upcoming events. In particular, the insight interfaces 400, 500, 600 herein represent the various multiple tags from the accessed event data for the particular event at issue and the categories/industries associated with the accessed transaction data for the events, so that the user is able to identify potential advertising opportunities for the future event based on a relative representation of the multiple tags and/or the categories in the insight interface. In particular in the illustrated interfaces 400, 500, 600, the various tags and categories represented in large text sizes represent an increased presence/usage of those terms/categories among consumers that are more likely to make purchases of products for future events related to the events shown in the interfaces 400, 500, 600.

In an example application, tickets may still be available for an upcoming event involving the Band ABC. Through the insight interface 400 (and the insight interface 500), the user 122 may see that a large index of potential consumers make transactions at wholesale trade merchants (from interface 400) and at consumer electronic merchants (from interface 500). As such, the user 122 may effect an online advertising word purchase, and related advertisement, directed to people that searches for “lumber” or “electronics” or related words. In addition, or alternatively, the user 122 may identify possible affiliate market possibilities, either online or offline, including, for example, identifying key blogs, websites, etc., related to wholesale trade and/or consumer electronics.

As can now be appreciated, the systems and methods herein may allow users, via the event engine 120, for example, to distinguish live events, determine where event attendees shop and what products they purchase, determine where and how to market similar events, determine what consumer profiles would be most receptive to upcoming events, and/or determine what consumers would be most likely to respond to various merchant offers.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing event data associated with a prior event, the event data including one or more tags associated with the prior event, (b) accessing transaction data for the one or more consumers, the transaction data identified based on transactions involving one or more merchants at and/or associated with the prior event, (c) filtering the accessed transaction data based on a time and/or a date associated with the prior event; (d) compiling an aggregate consumer profile for the one or more consumers based on the accessed transaction data, the aggregate consumer profile including one or more categories of transactions included in the accessed transaction data; (e) compiling an insight interface; (f) incorporating at least one category symbol indicative of at least one of the one or more categories in the aggregate consumer profile into a first segment of the insight interface and incorporating at least one tag symbol indicative of at least one of the one or more tags associated with the accessed event data into a second segment of the insight interface; and (g) causing an insight interface to be delivered to a user associated with a future event, the insight interface representing the one or more tags from the accessed event data and the one or more categories associated with the accessed transaction data, whereby the user is able to identify from the insight interface potential advertising opportunities for the future event based on a relative representation of the one or more tags and/or the categories in the insight interface.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term “product” may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.” Nonetheless, the claims may be amended, within the scope of the present disclosure, at a later time, to expressly includes means for and/or step for recitations within the meaning of 35 U.S.C. §112(f). Specifically, for example, the engine 120, for example, may include means for accessing event data associated with a prior event, the event data including one or more tags associated with the prior event; accessing transaction data for one or more consumers, based on transactions involving one or more merchants at and/or associated with the prior event; compiling an aggregate consumer profile for the one or more consumers based on the accessed transaction data, the aggregate consumer profile including one or more categories of transactions included in the accessed transaction data; causing an insight interface to be delivered to a user associated with a future event; etc., or other means/structures for performing method steps herein.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### COMPUTER CODE APPENDIX

```
## Interactive Map ###########################################
# Create the map
output$map <- renderLeaflet({
  leaflet( ) %>%
    addTiles(
      urlTemplate = ″//{s}.files.mapbox.com/v3/jcheng.map-5ebohr46/{z}/{x}/{y}.png″,
      attribution = ′Maps by <a href=″http://www.mapbox.com/>Mapbox</a>′
    ) %>%
    setView(lng = −84.8, lat = 38.62, zoom = 5)
})
zipsInBounds <- reactive({
  if (is.null(input$map_bounds))
    return(zipdata[FALSE,])
  bounds <- input$map_bounds
  latRng <- range(bounds$north, bounds$south)
  lngRng <- range(bounds$east, bounds$west)
  this_event <- input$book
  subset(zipdata,
        latitude >= latRng[1] & latitude <= latRng[2] &
          longitude >= lgRng[1] & longitude <= lngRng[2]& event_id == this_event)
})
# A reactive expression that returns the zip data of the selected event
zipsEvent <- reactive({
  this_event <- input$book
  subset(zipdata, event id == this_event)
})
output$tagsCloud <- renderImage({
  f1 <- paste(″./tag_clouds/″,input$book,″.png″, sep = ″ ″)
  return(list(
    src = f1,
    contentType = ″image/png″,
    width = 266,
    height = 200,
    alt = ″Tags″
  ))
}, deleteFile = FALSE)
output$industryCloud <- renderImage({
  f1 <- paste(″./ind_clouds/″,input$book,″.png″, sep = ″ ″)
  return(list(
    src = f1,
    contentType = ″image/png″,
    width = 400,
    height = 300,
    alt = ″Industries″
  ))
}, deleteFile = FALSE)
# Precalculate the breaks we'll need for the two histograms
ylim = range(allzips$income)))
  observe({
    eventBy <- input$book
    colorBy <- input$color
sizeBy <- ″count″ #input$size
if (colorBy == ″superzip″) {
  colorData <- ifelse(zipdata$centile >= (100 - input$threshold), ″yes″, ″no″)
  pal <- colorFactor(″Spectral″, colorData)
} else {
  colorData <- zipdata[[colorBy]]
  pal <- colorBin(″Spectral″, colorData, 7, pretty = FALSE)
}
if (sizeBy == ″superzip″) {
  # Radius is treated specially in the ″superzip″ case.
  radius <- ifelse(zipdata$centile >= (100 - input$threshold), 30000, 3000)
} else {
  radius <- zipdata[[sizeBy]] / max(zipdata[[sizeBy]]) * 30000
}
tmpZip <- subset(zipdata, event_id == eventBy)
leafletProxy(″map″, data = tmpZip) %>%
  clearShapes( ) %>%
  addCircles(~longitude, ~latitude, radius=radius, layerId=~zipcode,
    stroke=FALSE, fillOpacity=0.4, fillColor=pal(colorData)) %>%
  addLegend(″bottomleft″, pal=pal, values=colorData, title=colorBy,
    layerId=″colorLegend″)
})
# Show a popup at the given location
showZipcodePopup <- function(zipcode, lat, lng) {
  selectedZip <- allzips[allzips$zipcode == zipcode ,]
  content <- as.character(tagList(
      tags$h4(″Score:″, as.integer(selectedZip$centile)),
      tags$strong(HTML(sprintf(″%s, %s %s″,
        selectedZip$city.x, selectedZip$state.x, selectedZip$zipcode
      ))), tags$br( ),
      sprintf(″Median household income: %s″, dollar(selectedZip$income * 1000)),
tags$br( ),
      sprintf(″Percent of adults with BA: %s%%″, as.integer(selectedZip$college)),
tags$br( ),
      sprintf(″Adult population: %s″, selectedZip$adultpop)
    ))
    leafletProxy(″map″) %>% addPopups(lng, lat, content, layerId = zipcode)
  }
  # When map is clicked, show a popup with city info
  observe({
    leafletProxy(″map″) %>% clearPopups( )
    event <- input$map_shape_click
    if (is.null(event))
      return( )
    isolate({
      showZipcodePopup(event$id, event$lat, event$lng)
    })
  })
[[break between code segments]]
library(shiny)
library(leaflet)
vars <- c(
#CJM ″Is SuperZIP?″ = ″superzip″,
#CJM ″Centile score″ = ″centile″,
  ″College education″ = ″college″,
  ″Median income″ = ″income″,
  ″Population″ = ″adultpop″,
  ″Prior 30 Days Txns″ = ″count″
)
books <<- list(″Fleetwood Mac″ = ″E0-001-076623912-9.txt″,
        ″Jeff Beck″ = ″E0-001-082680063-6.txt″,
        ″Yonder Mountain″ = ″E0-001-077874483-7.txt″,
        ″Alabama Shakes with Father John Misty″ = ″E0-001-081043891-5.txt″,
        ″Ed Sheeran″ = ″E0-001-080884408-9.txt″,
        ″50 Shades The musical″ = ″E0-001-078447182-6.txt″,
        ″The Rat pack is back″ = ″E0-001-073534301-1.txt″,
        ″Disney on Ice : New Disney″ = ″E0-001-070899711-7@2015030115.txt″,
        ″The Main Event: Nkotb With Very Special Guests Tlc And Nelly″ = ″E0-001-
079780878-3.txt″,
        ″Atmosphere″ = ″E0-001-080874927-0.txt″,
        ″National Public Radio Presents: \″Ask Me Another\″ - A Live Performance″ =
″E0-001-080715377-7.txt″,
        ″Professional Bull Riders Built Ford Tough Series″ = ″E0-001-074419367-
6@2015021519.txt″,
        ″Demetri Martin″ = ″E0-001-077373919-5.txt″,
        ″The Who″ = ″E0-001-076623990-7.txt″)
shinyUI(navbarPage(″FanBase″, id=″nav″,
  tabPanel(″Interactive map″,
    div(class=″outer″,
  tags$head(
    # Include our custom CSS
    includeCSS(″styles.css″),
    includeScript(″gomap.js″)
  ),
  leafletOutput(″map″, width=″100%″, height=″100%″),
  absolutePanel(id =″controls″, class = ″panel panel-default″, fixed = TRUE,
    draggable = TRUE, top = 60, left = ″auto″, right = 20, bottom = ″auto″,
    width = 430, height = ″auto″,
    h2(″FanBase″),
    selectInput(″book″, ″Event″, books, selected = ″E0-001-076623912-9.txt″),
    selectInput(″color″, ″Color″, vars, selected = ″count″),
    #CJM selectInput(″size″, ″Size″, vars, selected = ″adultpop″),
    conditionalPanel(″input.color == ′superzip′ || input.size == ′superzip′″,
      numericInput(″threshold″, ″SuperZIP threshold (top n percentile)″, 5)
    ),
    h5(″Event Tags″),
    plotOutput(″tagsCloud″, height = 200),
    h5(″Event Industries″),
    plotOutput(″industryCloud″, height = 300)
  ),
  tags$div(id=″cite″,
    ′Data compiled for′, tags$em(′Coming Apart: The State of White America,
1960â [symbol] “2010′), ′by Charles Murray (Crown Forum, 2012).′
      )
    )
  ),
  tabPanel(″Data explorer″,
    fluidRow(
      column(3,
        selectInput(″states″, ″States″, c(″All states ″=″ ″, structure(state.abb,
names=state.name), ″Washington, DC″=″DC″), multiple=TRUE)
      ),
      column(3,
        conditionalPanel(″input.states″,
          selectInput(″cities″, ″Cities″, c(″All cities ″=″ ″), multiple=TRUE)
        )
      ),
      column(3,
        conditionalPanel(″input.states″,
          selectInput(″zipcodes″, ″Zipcodes″, c(″All zipcodes″=″ ″), multiple=TRUE)
        )
      )
    ),
    fluidRow(
      column(1,
        numericInput(″minScore″, ″Min score″, min=0, max=100, value=0)
      ),
      column(1,
        numericInput(″maxScore″, ″Max score″, min=0, max=100, value=100)
      )
    ),
    hr( ),
    DT::dataTableOutput(″ziptable″)
  ),
  conditionalPanel(″false″, icon(″crosshair″))
))
```

What is claimed is:

1. A computer-implemented method for use in identifying advertising opportunities for future events, based on event data for prior events and transaction data for consumers attending the prior events, the method comprising:
accessing, by a computing device, event data associated with a prior event, the event data including one or more tags associated with the prior event;
accessing, by the computing device, transaction data for one or more consumers, based on transactions involving one or more merchants at and/or associated with the prior event;
compiling, by the computing device, an aggregate consumer profile for the one or more consumers based on the accessed transaction data, the aggregate consumer profile including one or more categories of transactions included in the accessed transaction data; and
causing an insight interface to be delivered to a user associated with a future event, the insight interface representing the one or more tags from the accessed event data and the one or more categories associated with the accessed transaction data, whereby the user is able to identify, from the insight interface, potential advertising opportunities for the future event based on a relative representation of the one or more tags and/or the categories in the insight interface.

2. The computer-implemented method of claim 1, wherein the insight interface includes a geographic representation of a region of the prior event.

3. The computer-implemented method of claim 1, further comprising compiling the insight interface, and incorporating at least one category symbol indicative of at least one of the one or more categories in the aggregate consumer profile into a first segment of the insight interface and incorporating at least one tag symbol indicative of at least one of the one or more tags associated with the accessed event data into a second segment of the insight interface.

4. The computer-implemented method of claim 3, wherein the insight interface includes one or more tag symbols, each tag symbol associated with one of the one or more tags; and
wherein each tag symbol is visually representative of a frequency of the tag represented thereby, in the event data, relative to a frequency of other tags in the event data.

5. The computer-implemented method of claim 4, wherein each symbol is visually representative of a term frequency-inverse document frequency (TF-IDF) of the tag represented thereby in the event data.

6. The computer-implemented method of claim 5, wherein a size and/or a color of each symbol is visually representative of the TF-IDF of the tag represented thereby.

7. The computer-implemented method of claim 4, wherein the insight interface includes one or more category symbols, each category symbol associated with one of the one or more categories included in the aggregate consumer profile; and
wherein each category symbol is visually representative of a frequency of the category represented thereby relative to a frequency of other categories in the aggregate consumer profile.

8. The computer-implemented method of claim 1, further comprising filtering the accessed transaction data based on a time and/or a date associated with the prior event; and
wherein compiling the aggregate consumer profile includes compiling the aggregate consumer profile based on the filtered transaction data.

9. The computer-implemented method of claim 1, wherein the insight interface includes:
a category symbol having a color and/or a size indicative of occurrence of a category associated therewith in the accessed transaction data, relative to other categories in the accessed transaction data; and/or
a tag symbol having a color and/or a size indicative of occurrence of a tag associated therewith in the accessed event data, relative to other tags in the accessed event data.

10. A non-transitory computer readable storage media including executable instructions for identifying advertising opportunities for events, which when executed by at least one processor, cause the at least one processor to:
compile an event data structure having one or more tags from event data associated with a prior event that has already occurred;
compile an aggregate consumer profile for consumers having payment accounts with at least one transaction at the prior event, the aggregate consumer profile including one or more categories of transactions associated with the payment accounts of the consumers;
compile an insight interface for the prior event using the event data in the event data structure and using the aggregate consumer profile, the insight interface including a relative illustration of the one or more tags from the event data structure based on occurrence of the one or more tags in the event data associated with the prior event and a relative illustration of the one or more categories of transactions included in the aggregate consumer profile based on occurrence of the one or more categories in transaction data for the transactions associated with the payment accounts of the consumers; and
transmit the insight interface to a user associated with a future event so that the user is able to identify potential advertising opportunities for the future event based on the relative illustrations of the one or more tags and/or the categories in the insight interface compiled the prior event.

11. The non-transitory computer readable storage media of claim 10, wherein the instructions, when executed by at least one processor, further cause the at least one processor to:
access transaction data in association with at least one of a payment network configured to process purchase transactions and an issuer configured to issue payment accounts to consumers for use in purchase transactions; and
filter the accessed transaction data based on a predefined time interval and/or a predefined date interval for the prior event, in order to identify the payment accounts of the consumers including the at least one transaction at the prior event.

12. The non-transitory computer readable storage media of claim 11, wherein the at least one transaction at the prior event includes one or more of a transaction at a merchant associated with the prior event within the predefined time interval and/or the predefined date interval for the prior event, and/or a transaction at an automated teller machine (ATM) associated with the prior event within the predefined time interval and/or the predefined date interval for the prior event.

13. The non-transitory computer readable storage media of claim 11, wherein the insight interface includes a geographic representation of a region in which the prior event was located; and
wherein the relative illustration of the one or more tags from the event data structure and the relative illustration of the one or more categories of transactions from the aggregate consumer profile are included in the insight interface with the geographic representation.

14. The non-transitory computer readable storage media of claim 13, wherein the relative illustration of the one or more tags from the event data structure includes different sizes and/or colors for different ones of the one or more tags; and
wherein the relative illustration of the one or more categories of transactions from the aggregate consumer profile includes different sizes and/or colors for different ones of the one or more categories.

15. The non-transitory computer readable storage media of claim 14, wherein the relative illustration of the one or more tags is based on a term frequency-inverse document frequency (TF-IDF) of the tags in the event data; and
wherein the relative illustration of the one or more categories is based on a TF-IDF of the one or more categories in the transaction data for the transactions associated with the payment accounts of the consumers.

16. The non-transitory computer readable storage media of claim 13, wherein the insight interface further includes indicators representing a selected measure associated with the transactions to the payment accounts of the consumers and located on the geographic representation of the region in which the prior event was located based on one of merchant zip codes of where the underlying transactions were observed and consumer zip codes for the payment accounts to which the transactions are associated.

17. The non-transitory computer readable storage media of claim 13, wherein the instructions, when executed by at least one processor, further cause the at least one processor to identify the prior event, in response to a query from the user, based at least in part on the tags from the event data associated with the prior event.

18. A system for use in identifying advertising opportunities for future events, based on event data for prior events and transaction data for consumers attending the prior events, the system comprising:
a memory including an event data structure having event data for a prior event that has already occurred, and an aggregate consumer profile associated with the prior event and identifying one or more categories of transactions to payment accounts of consumers attending the prior event; and
a processor in communication with the memory, the processor configured to:
in response to a search request by a user regarding a future event, identify the prior event in the memory from one or more different prior events based on the event data in the event data structure, and retrieve the event data structure from the memory;
retrieve, from the memory, the aggregate consumer profile associated with the prior event;
compile an insight interface for the prior event using the event data in the event data structure and using the aggregate consumer profile, the insight interface including a relative illustration of one or more tags from the event data structure based on occurrence of the one or more tags in the event data associated with the prior event and a relative illustration of the one or more categories of transactions included in the aggregate consumer profile based on occurrence of the one or more categories in transaction data for the transactions associated with the payment accounts of the consumers; and
cause delivery of the insight interface to the user event so that the user is able to identify potential advertising opportunities for the future event based on the relative illustrations of the one or more tags associated with the prior event and/or the categories associated with the prior event in the insight interface.

19. The system of claim 18, wherein the processor is configured to:
compile the event data structure and store the event data structure in the memory; and
compile the aggregate consumer profile for the consumers and store the aggregate consumer profile in memory;

20. The system of claim 19, wherein the processor is configured to:
in connection with compiling the aggregate consumer profile for the consumers attending the prior event, access transaction data in association with at least one of a payment network configured to process purchase transactions to payment accounts of consumers and an issuer configured to issue the payment accounts to the consumers for use in performing the purchase transactions; and
filter the accessed transaction data based on a predefined time interval and/or a predefined date interval for the prior event, in order to identify the payment accounts of the consumers attending the prior event, based on the payment accounts including at least one transaction at a merchant and/or an automated teller machine (ATM) associated with the prior event.
